(19) United States
(12) Patent Application Publication
(10) Pub. No.: US 2010/0126599 A1
(43) Pub. Date: May 27, 2010

(54) PILOT OPERATED CHECK VALVE

(76) Inventor: Bjørn H. Nilssen, Sandnes (NO)

Correspondence Address: PATTERSON & SHERIDAN, L.L.P., 3040 POST OAK BOULEVARD, SUITE 1500, HOUSTON, TX, 77056, US

(21) Appl. No.: 12/301,455

(22) PCT Filed: Jun. 14, 2007
(86) PCT No.: PCT/NO2007/000207

§ 371 Date: Nov. 18, 2008

(30) Foreign Application Priority Data
Jun. 15, 2006 (NO) 20062782

(51) Int. Cl. F16K 31/122

(52) U.S. Cl. 137/485

(57) ABSTRACT

A pilot-operated check valve (1) including a valve housing (2) and a main slide (4), the main slide (4) being movable between a first and a second position in the valve housing (2), the main slide (4) communicating with at least two main ports (20, 22) in the valve housing (2), and a movable valve body (42), which cooperates with a valve seat (40) in the main slide (4), being arranged to block flow in a first direction between the main ports (20, 22), and to open to flow in an opposite second direction between the main ports (20, 22), and the valve body (42) bearing in an opening manner, possibly via intermediate components (30, 52), against the valve housing (2) when the main slide (6) is in its second position in the valve housing (2), whereby opening to flow in the first direction takes place.

This invention relates to a pilot-operated check valve. More particularly, it relates to a pilot-operated check valve comprising a valve housing and a main slide, the main slide being movable between a first and a second position in the valve housing. The main slide communicates with at least two main ports in the valve housing. A movable valve body, which cooperates with a valve seat in the main slide, is arranged to block flow in a first direction between the main ports and to open to flow in the opposite direction between the ports. The valve body bears in an opening manner, possibly via intermediate components, against the valve housing when the main slide is in its second position in the valve housing.

Prior art pilot-operated check valves often include a valve body which bears in a biasing manner against a valve seat in a valve housing. Fluid pressure in a first direction has the effect of further increasing the closing force of the valve body against the valve seat. If it is desirable to open to flow in this first direction, the valve body is moved away from the valve seat by means of a normally fluid-operated actuator.

Fluid pressure in a second direction flows through the valve by the bias against the valve body being overcome and the valve body thereby being moved away from the valve seat.

Valves of this kind are well suited for applications in which the opening to flow through the valve in the first direction may be carried out by supplying the actuator with pressurized fluid with a good pressure margin, that is to say that the pressure supplied to the actuator is substantially higher than the pressure which is normally necessary for the check valve to be opened.

If it is necessary to be able to open the valve to flow in the first direction at a relatively accurate pilot pressure and mainly independently of what pressure is acting in a closing manner on the valve body, it has turned out to be difficult for prior art valves, in particular when there is a question of opening at a relatively high pilot pressure, to achieve satisfactory functional reliability.

The invention has for its object to remedy or reduce at least one of the drawbacks of the prior art.

The object is achieved in accordance with the invention through the features, which are specified in the description below and in the claims that follow.

A pilot-operated check valve in accordance with the invention comprises a valve housing and a main slide, the main slide being movable between a first and a second position in the valve housing, and the main slide communicating with at least two main ports, a movable valve body, Cooperating with a valve seat in the main slide, being arranged to block flow in a first direction between the main ports, and to open to flow in the opposite direction between the main ports. The check valve is characterized by the valve body bearing in an opening manner, possibly via intermediate components, against the valve housing when the main slide is in its second position in the valve housing.

The valve body is typically in a longitudinal bore in the main slide, the valve body being moved in a biasing manner against the valve seat by means of a closing spring.

The length of movement of the main slide in the valve housing may be limited by a stop connected to the valve housing, the stop possibly projecting, for example, into an elongated groove in the main slide.

In a practical design a release element will extend between the valve body and the stop.

The main slide is biased in the direction of its first position in the valve housing by a main spring bearing against one end portion of the main slide. The main spring typically also braces against an adjustment screw in the valve housing.

At its opposite end portion relative to the main spring the main slide is provided with a piston surface. Fluid pressure against the piston surface results in a displacement force on the main slide in the direction of the second position of the main slide in the valve housing. By sufficient pressure on the piston surface the force of the main spring is overcome, whereby the main slide is moved from its first position in the valve housing into its second position in the valve housing.

By the fact that the length of movement of the main slide is relatively short and the necessary opening force against the valve housing is relatively small, a pilot-operated check valve according to the invention will open to flow in the first direction within a relatively small pilot pressure interval.

In what follows is described a non-limiting example of a preferred embodiment which is visualized in the accompanying drawings, in which:

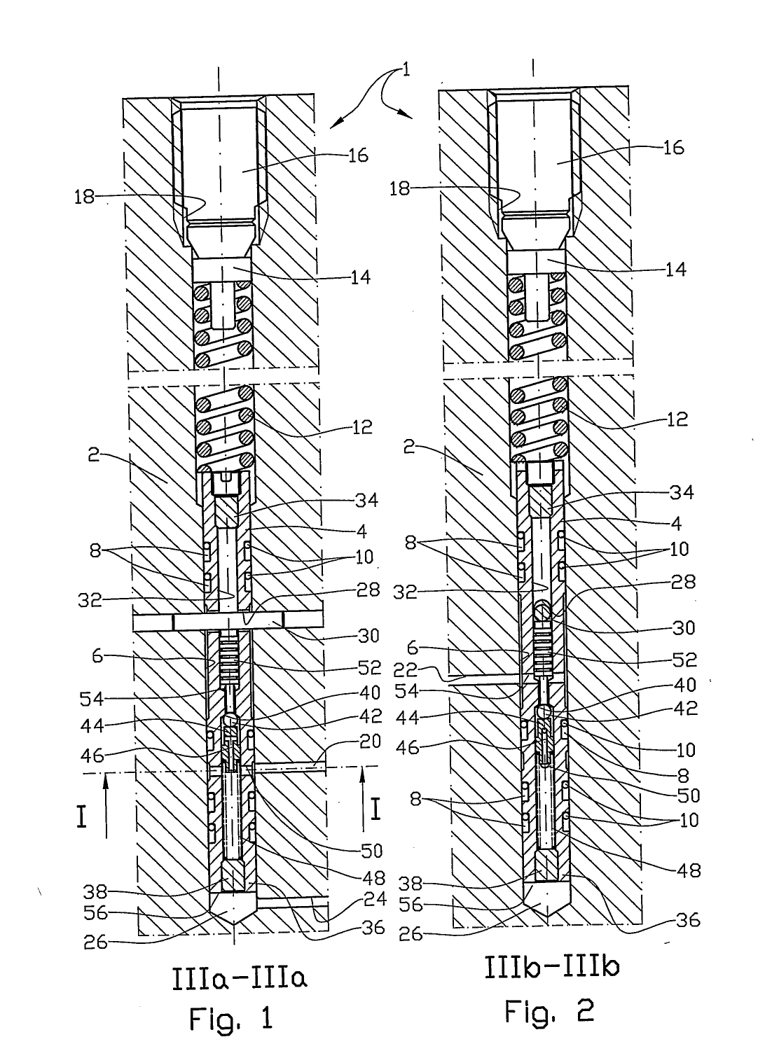

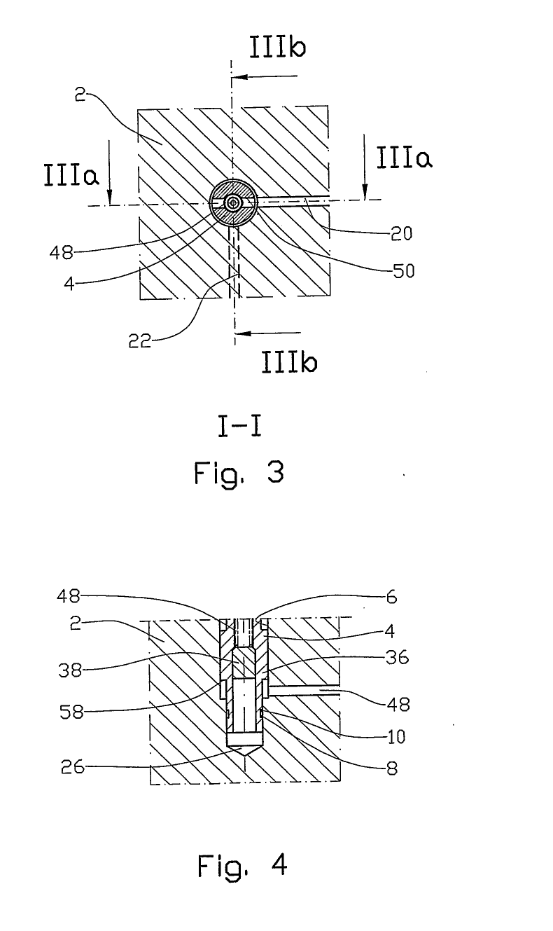

FIG. 1 shows a section IIIa-IIIc of FIG. 3 of a pilot-operated check valve according to the invention;

FIG. 2 shows a section IIIb-IIIb of FIG. 3;

FIG. 3 shows a section I-I of FIG. 1; and

FIG. 4 shows an alternative embodiment of the pilot part of the check valve.

In the drawings the reference numeral 1 indicates a pilot-operated check valve including a valve housing 2 and a main slide 4, the main slide 4 being movably arranged in a main bore 6 in the valve housing 2.

The main slide 4 is provided with encircling seal grooves 8, in which are arranged, in a manner known per se, seals 10 to prevent unintentional fluid flow between the main slide 4 and the main bore 6.

A main spring 12 extends in a biasing manner in a somewhat reamed portion of the main bore 6 between the main slide 4 and a control washer 14 resting on an adjustment screw 16. The adjustment screw 16 is disposed in a threaded bore 18 in the valve housing 2. The threaded bore 18 is arranged concentrically in the extension of the main bore 6.

A first main port 20 and a second main port 22 open into the main bore 6 with interspacing along the main bore 6, whereas a pilot port 24 opens into the bottom portion 26 of the main bore 6. Additionally, the valve housing 2 is provided with necessary drain channels, not shown.

Transversally to its moving direction the main slide 4 is provided with an oval opening 28 extending through it. The largest diameter of the oval opening 28 coincides with the longitudinal direction of the main slide 4. A stop 30 in the form of a cylindrical axle, which is connected to the valve housing, extends through the oval opening 28. The length of movement of the main slide 4 in the main bore 6 is thereby limited by the stop 30.

Through the main slide 4 extends a stepped concentric longitudinal slide bore 32 which is closed at its end portion n facing the main spring 12 by means of a first plug 34, and is closed at its opposite end portion, at the pilot portion 36, by means of a second plug 38.

A shoulder 40 in the slide bore 32 forms a valve seat for a valve body 42, here in the form of a ball. A support slide 44, which is provided with a through channel 46, is moved in a biasing manner by means of a closing spring 48 against the valve body 42, whereby the valve body 42 bears in a biased manner against the valve seat 40. The force of the closing spring 48 is insignificant in relation to the force of the main spring 12.

The first main port 20 communicates via a first slide channel 50 with the slide bore 32 on the spring side of the support slide 44.

In the slide bore 32, between the stop 30 and the valve body 42, is disposed a release element 52. The second main port 22 communicates via a second slide channel 54 with the slide bore 32 on the release element side of the valve body 42.

The main spring 12 moves the main slide 4 inwards within the main bore 6 until the oval opening 28 hits the stop 30. The main slide 4 is now in its first position in the valve housing 2, see FIG. 1.

Pressurized fluid seeking to flow in a first direction of flow from the first main port 20 to the second main port 22 is prevented from such flow by the valve body 42 bearing sealingly against the valve seat 40, the pressurized fluid thereby causing the valve body 42 to be further braced against the valve seat 40.

Pressurized fluid seeking to flow in a second direction from the second main port 22 to the first main port 20 overcomes the force of the closing spring 48 on the valve body 42. The valve body 42 is thereby moved together with the support slide 44 in a direction away from the valve seat 40. Thereby, fluid may flow from the second main port 22, via the second slide channel 54, slide bore 32, valve seat 40, channel 46 in the support slide 44 and the first slide channel 50 to the first main port 20.

The end surface of the pilot portion 36 of the main slide 4 forms, together with the second plug 38, a piston surface 56 for pressurized fluid entering the main bore 6 via the pilot port 24.

When the pressure in the pilot port 24 increases sufficiently, the pressure forces on the piston surface 56 overcome the force of the main spring 12, whereby the main slide 4 is moved in the direction towards the main spring 12 until the oval opening 28 hits the stop 30 on its opposite side, see FIG. 2. The main slide 4 is now in its second position in the valve housing 2. The length of the release element 52 is adapted in such a way that just before the main slide reaches its second position, the release element 52 hits the valve body 42 and stop 30. Thereby, the valve body 42 is moved out from the valve seat 40. When the main slide 4 is in its second position in the valve housing 2, fluid may flow in the first direction of flow from the first main port 20 via the first slide channel 50, slide bore 32, channel 46, valve seat 40 and second slide channel 54 to the second main port 22.

When the pressure in the pilot port 24 is relieved, the main spring 12 returns the main slide 4 into the first position in the valve housing 2, whereby the valve body 42 closes to flow in the first direction of flow.

The check valve 1 is balanced in the sense that pressure from fluid in the main ports 20 and 22 only to a quite insignificant degree applies resulting axial forces to the main slide 4.

When a check valve 1 is involved which is to open only at a relatively high pilot pressure, it is, for practical reasons, not convenient to use a main spring 12 having correspondingly great tension.

The piston surface 56 is therefore reduced to an annular area 58, see FIG. 4, by stepping down the pilot portion 36.

1. A pilot-operated check valve including a valve housing and a main slide, the main slide being movable between a first and a second position in the valve housing, the main slide communicating with at least two main ports in the valve housing, and a movable valve body, which cooperates with a valve seat in the main slide, being arranged to block flow in a first direction between the main ports, and to open to flow in an opposite second direction between the main ports, characterized in that the valve body bears in an opening manner, possibly via intermediate components, against the valve housing when the main slide is in its second position in the valve housing, whereby opening to flow in the first direction takes place.

2. The device in accordance with claim 1, characterized in that the valve body is in a longitudinal bore in the main slide.

3. The device in accordance with claim 1, characterized in that the length of movement of the main slide in the valve housing is limited by a stop connected to the valve housing.

4. The device in accordance with claim 3, characterized in that a release element extends between the valve body and the stop.

5. The device in accordance with claim 1, characterized in that the main slide is biased by a main spring in the direction of its first position in the valve housing.

6. The device in accordance with claim 1, characterized in that the main slide is provided with a piston surface, fluid pressure on the piston surface resulting in a displacing force on the main slide in the direction of the second position of the main slide in the valve housing.
